(19) United States
(12) Patent Application Publication
(10) Pub. No.: US 2013/0188638 A1
(43) Pub. Date: Jul. 25, 2013

(54) Multicast Source Registration

(71) Applicants: Stig I. Venaas, Oakland, CA (US); Rishabh Parekh, San Jose, CA (US); Sameer R. Gulrajani, Fremont, CA (US); Toerless T. Eckert, Mountain View, CA (US); Isidoros Kouvelas, Halandri (GR)

(72) Inventors: Stig I. Venaas, Oakland, CA (US); Rishabh Parekh, San Jose, CA (US); Sameer R. Gulrajani, Fremont, CA (US); Toerless T. Eckert, Mountain View, CA (US); Isidoros Kouvelas, Halandri (GR)

(73) Assignee: Cisco Technology, Inc., San Jose, CA (US)

(21) Appl. No.: 13/356,302

(22) Filed: Jan. 23, 2012

(51) Int. Cl. H04L 12/56

(52) U.S. Cl. 370/390

(57) ABSTRACT

A method, in accordance with particular embodiments, includes receiving an interest solicitation message advertising an availability of data from at least one source of a plurality of sources. The solicitation message comprises a source identifier indentifying the at least one source and a group identifier identifying at least one group. The method also includes sending a null message to a rendezvous node. The null message comprises the source identifier and the group identifier. The method additionally includes receiving, via the rendezvous node, a join message indicating that at least one endpoint has requested to join the at least one group identified by the group identifier. The method further includes sending a start message to the at least one source. The start message indicates that at least one endpoint has requested to join the group. The method also includes, receiving a first portion of the data after sending the start message.

### TECHNICAL FIELD

The present disclosure relates generally to multicast source registration.

### BACKGROUND

In Internet Group Management Protocol (IGMP) different endpoints are able to receive multicast data by subscribing to a group associated with the desired multicast data. Once the endpoint joins the group, it begins receiving multicast data from a source of the data. In joining a group, it is not necessary for the endpoint to know the identity of the source of the data. Rather, the endpoint only needs to know the identity of the group associated with the data. The endpoint is then able to send a join request to a rendezvous node. The join request simply identifies the group. The rendezvous node then begins the process of sending the data from the source associated with the identified group to the endpoint.

When the source is registering with the rendezvous node, the data from the source is sent to the rendezvous node in an encapsulated format. Unfortunately, the source may be sending the encapsulated data even when there are no endpoints currently joined to the group. This is a waste of the source's resources and network resources.

### BRIEF DESCRIPTION OF THE FIGURES

For a more complete understanding of particular embodiments and their advantages, reference is now made to the following description, taken in conjunction with the accompanying drawings, in which:

FIG. 1 illustrates a block diagram of a network configured to multicast data from a plurality of sources to a plurality of endpoints via a rendezvous node, in accordance with particular embodiments;

FIG. 2 illustrates a detailed block diagram of a first-hop node in a network configured to multicast data from a plurality of sources to a plurality of endpoints via a rendezvous node, in accordance with particular embodiments; and

FIG. 3 illustrates a method for implementing multicast source registration, in accordance with particular embodiments.

### DESCRIPTION OF EXAMPLE EMBODIMENTS

### Overview

A method, in accordance with particular embodiments, includes receiving an interest solicitation message advertising an availability of data from at least one source of a plurality of sources. The solicitation message comprises a source identifier indentifying the at least one source and a group identifier identifying at least one group. The method also includes sending a null message to a rendezvous node. The null message comprises the source identifier and the group identifier. The method additionally includes receiving, via the rendezvous node, a join message indicating that at least one endpoint has requested to join the at least one group identified by the group identifier. The method further includes sending a start message to the at least one source. The start message indicates that at least one endpoint has requested to join the group. The method also includes receiving a first portion of the data after sending the start message.

### Example Embodiments

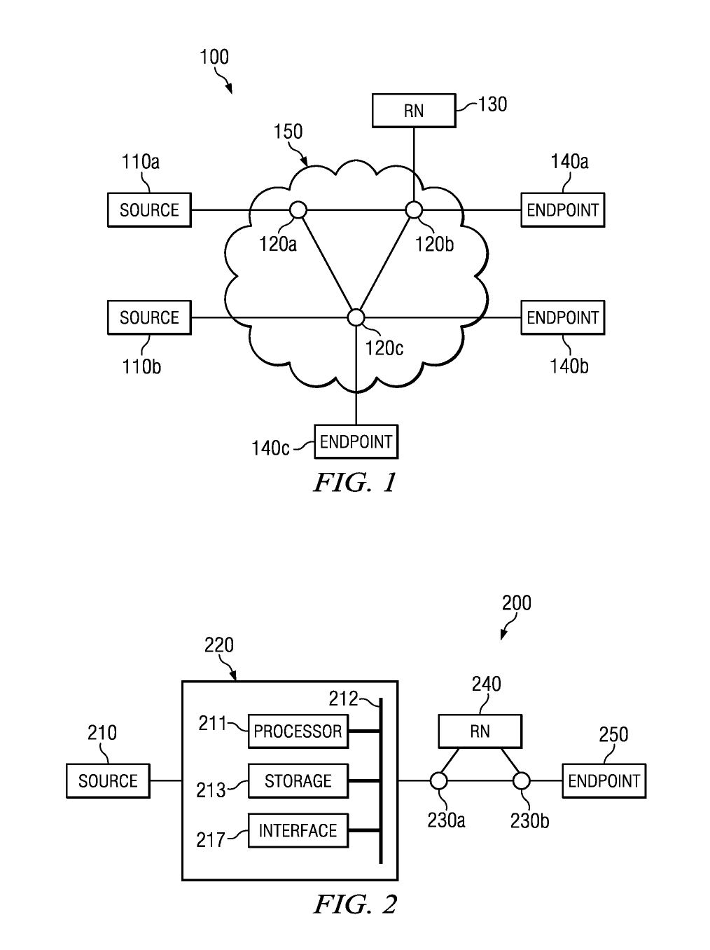

FIG. 1 illustrates a block diagram of a network configured to multicast data from a plurality of sources to a plurality of endpoints via a rendezvous node, in accordance with particular embodiments. In the depicted embodiment, network 100 comprises sources 110, nodes 120, rendezvous node (RN) 130, endpoints 140, and sub-network 150. The depicted components of network 100 may work together to provide multicast data from one or more sources 110 to one or more endpoints 140. The depicted embodiment may conserve the resources of network 100 and/or sources 110 by only transmitting and/or relaying multicast data when there are endpoints registered or joined to a group interested in the multicast data. By only relaying multicast data when there are interested endpoints, network 100 may reduce or eliminate the resources wasted on routing multicast data that no endpoint is currently interested in receiving. In particular embodiments, this waste may be prevented by, for example, node 120a, sending null messages (e.g., null-register messages) to RN 130. The null messages may be sent to RN 130 instead of messages with encapsulated data (as is typically done in other multicast environments). The null messages may register the source 110a with RN 130 and/or inform RN 130 that source 110a has multicast data that is available for any interested group members.

Sources 110 may comprise any combination of hardware components and/or software or logic encoded in a non-transitory computer readable medium for execution by a processor. Sources 110 may be any of a variety of different data sources configured to multicast data to a number of endpoints. For example, in some embodiments, sources 110a and 110b may be streaming video sources, streaming audio sources, or any other source of multicast data to which endpoints 140 may subscribe. As used herein, multicast data may refer to any type of data that is broadcast or otherwise sent to a number of endpoints. Sources 110 may wait to send their respective data until after they receive a corresponding start message indicating that there are members in the corresponding group. In certain embodiments, sources 110 may use internet group management protocol (IGMP) and/or multi-cast source notification of interest protocol (MSNIP).

In particular embodiments, each source 110 may announce, or otherwise advertise, when it has data that is available for multicast. The announcement may comprise a message (e.g., an interest solicitation message) that is sent to a first-hop node (e.g., the first node within sub-network 150 to which the source is connected). For example, if source 110b has data available for a group, it may send a message to node 120c advertising the availability of the data.

The message advertising the data may include a group identifier and/or address and a source identifier and/or address. This may allow the announcement to identify where the data is coming from as well as for whom the data is being made available (e.g., members of group). The first-hop node may then communicate the received information to RN 130. RN 130 may store the information for later use should any endpoints join the group and wish to receive the data from the source. The announcement may not include the actual multicast data. This may save network and/or source resources from being used to multicast data until endpoints have joined the group.

Nodes 120 may comprise any combination of hardware components and/or software or logic encoded in a non-transitory computer readable medium for execution by a processor. Nodes 120 may comprise any of a variety of different sub-network 150 components implementing any number of communication protocols. For example, nodes 120 may comprise any combination of session border controllers, gatekeepers, call managers, conference bridges, routers, hubs, switches, gateways, endpoints, edge points, and/or any other devices capable of sending and receiving data within sub-network 150. Nodes 120 may be interconnected through any number of additional nodes within sub-network 150. In certain embodiments, when a particular node, such as node 120a, receives an announcement from a source, for example, source 110a, the node may determine or locate a source identifier and a group identifier from the announcement. The node may then generate null register messages that include this information and send them to RN 130. The null register messages may include the source identifier and the group identifier without including any encapsulation of the multicast data from the source. Sending the null register messages without encapsulated multicast data may use a minimal amount of network resources to inform RN 130 that source 110a has multicast data available.

Endpoints 140 may comprise any combination of hardware components and/or software or logic encoded in a non-transitory computer readable medium for execution by a processor. Endpoints 140 may comprise any devices or components of devices that may be interested in receiving multicast data from one or more sources 110. When a particular endpoint, such as endpoint 140a, wants to receive a particular multicast data stream, the endpoint may send a join message to RN 130. The join message may specify the group identifier that corresponds to the group identifier of the desired multicast data stream. It may not be necessary for the endpoint to know the source identifier for the source providing the multicast stream. Rather, endpoint 140a may simply need to know the group identifier. RN 130 may then match the requested group with the corresponding source or sources to then allow endpoint 140a to receive the desired multicast data.

RN 130 may comprise any combination of hardware components and/or software or logic encoded in a non-transitory computer readable medium for execution by a processor. In certain embodiments, RN 130 may, in essence, function as a middle-man or information broker between sources 110 and endpoints 140. For example, RN 130 may store a database, look-up table, or other organization of data which correlates particular sources of multicast data, such as source 110a, with particular groups. RN 130 may be able to identify a source of data, such as source 110a, based on a group identifier in a join request from an endpoint, such as endpoint 140b. In some embodiments, based on the join message, RN 130 may help establish a connection between the requesting endpoint and the corresponding source so that the endpoint can receive the multicast data from the source.

Sub-network 150 may include any combination of networks of different types and sizes that enables the communication of data using any of a variety of different protocols such as IGMP and/or MSNIP. For example, sub-network 150 may comprise one or more wide area networks (WANs), local area networks (LANs), metropolitan area networks (MANs), virtual LANs (VLANs), personal area networks (PANs), globally distributed networks (e.g., the Internet), intranets, extranets, or any other forms of wireless or wireline communication networks. The term “network” should be interpreted as generally defining any interconnection of components capable of transmitting data and/or signals including audio and/or video communication signals, data, and/or messages; and signals, data and/or messages transmitted through text chat, instant messaging, file transfer, and/or e-mail.

The number, type, and arrangement of components depicted in FIG. 1 is just one possible embodiment. Other embodiments may include any number of any type of component arranged in any suitable configuration.

FIG. 2 illustrates a detailed block diagram of a first-hop node in a network configured to multicast data from a plurality of sources to a plurality of endpoints via a rendezvous node, in accordance with particular embodiments. In the depicted embodiment, first-hop node 220 includes processor 211, storage 213, interface 217, and bus 212. These components may work together to relay multicast data in an efficient manner. Although first-hop node 220 is depicted having a particular number of particular components in a particular arrangement, this disclosure contemplates any suitable node having any suitable number of any suitable components in any suitable arrangement. While only the components of node 220 are depicted, other devices in network 200 may have similar components. Furthermore, although the example above describes certain components performing certain functions, particular embodiments may comprise similar or different components performing similar or different functions.

Processor 211 may be a microprocessor, controller, application specific integrated circuit (ASIC), field-programmable gate array (FPGA), or any other suitable computing device, resource, or combination of hardware with encoded software and/or embedded logic operable to provide, either alone or in conjunction with other components, (e.g., storage 213) first-hop node functionality. Such functionality may include alerting a rendezvous node, such as RN 240, of the availability of multicast data from a source, such as source 210, without sending the multicast data until there are interested endpoints. Additional examples and functionality provided, at least in part, by processor 211 will be discussed below.

In particular embodiments, processor 211 may include hardware for executing instructions, such as those making up a computer program. As an example and not by way of limitation, to execute instructions, processor 211 may retrieve (or fetch) instructions from an internal register, an internal cache, or storage 213; decode and execute them; and then write one or more results to an internal register, an internal cache, or storage 213.

In particular embodiments, processor 211 may include one or more internal caches for data, instructions, or addresses. This disclosure contemplates processor 211 including any suitable number of any suitable internal caches, where appropriate. As an example and not by way of limitation, processor 211 may include one or more instruction caches, one or more data caches, and one or more translation lookaside buffers (TLBs). Instructions in the instruction caches may be copies of instructions in storage 213 and the instruction caches may speed up retrieval of those instructions by processor 211. Data in the data caches may be copies of data in storage 213 for instructions executing at processor 211 to operate on; the results of previous instructions executed at processor 211 for access by subsequent instructions executing at processor 211, or for writing to storage 213; or other suitable data. The data caches may speed up read or write operations by processor 211. The TLBs may speed up virtual-address translations for processor 211. In particular embodiments, processor 211 may include one or more internal registers for data, instructions, or addresses. Depending on the embodiment, processor 211 may include any suitable number of any suitable internal registers, where appropriate. Where appropriate, processor 211 may include one or more arithmetic logic units (ALUs); be a multi-core processor; include one or more processors 211; or any other suitable processor.

Storage 213 may include any form of volatile or non-volatile memory including, without limitation, magnetic media, optical media, random access memory (RAM), read-only memory (ROM), flash memory, removable media, or any other suitable local or remote memory component or components. In particular embodiments, storage 213 may include random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM, or any other suitable type of RAM or memory. Storage 213 may include one or more memory or data storage modules, where appropriate. Storage 213 may store any suitable data or information utilized by first-hop node 220, including software embedded in a non-transitory computer readable medium, and/or encoded logic incorporated in hardware or otherwise stored (e.g., firmware). In particular embodiments, storage 213 may include main memory for storing instructions for processor 211 to execute or data for processor 211 to operate on. In particular embodiments, one or more memory management units (MMUs) may reside between processor 211 and storage 213 and facilitate accesses to storage 213 requested by processor 211.

In particular embodiments, storage 213 may include mass storage for data or instructions. As an example and not by way of limitation, storage 213 may include a hard disk drive (HDD), a floppy disk drive, flash memory, an optical disc, a magneto-optical disc, magnetic tape, or an external drive or a combination of two or more of these. Storage 213 may include removable or non-removable (or fixed) media, where appropriate. Storage 213 may include components internal or external to first-hop node 220, where appropriate. In particular embodiments, storage 213 may include non-volatile, solid-state memory. In particular embodiments, storage 213 may include read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. Storage 213 may take any suitable physical form and may comprise any suitable number or type of storage. Storage 213 may include one or more storage control units facilitating communication between processor 211 and storage 213, where appropriate.

As an example and not by way of limitation, first-hop node 220 may load instructions from one component of storage 213 (e.g., a hard-disk drive) or another source (such as, for example, another computer system) to another component of storage 213 (e.g., system memory). Processor 211 may then load the instructions from storage 213 to an internal register or internal cache. To execute the instructions, processor 211 may retrieve the instructions from the internal register or internal cache and decode them. During or after execution of the instructions, processor 211 may write one or more results (which may be intermediate or final results) to the internal register or internal cache. Processor 211 may then write one or more of those results to storage 213. In particular embodiments, processor 211 may execute only instructions in one or more internal registers or internal caches or in a particular portion of storage 213 and may operate only on data in one or more internal registers or internal caches or in a particular portion of storage 213.

In particular embodiments, interface 217 may include hardware, encoded software, or both providing one or more interfaces for communication (such as, for example, packet-based communication) between source 210, first-hop node 220, node 230a, RN 240, any networks, any network devices, and/or any other computer systems. As an example and not by way of limitation, communication interface 217 may include a network interface controller (NIC) or network adapter for communicating with an Ethernet or other wire-based network and/or a wireless NIC (WNIC) or wireless adapter for communicating with a wireless network.

Depending on the embodiment, interface 217 may be any type of interface suitable for any type of network. As an example, and not by way of limitation, interface 217 may be used to send and receive data in an ad-hoc network, a personal area network (PAN), a local area network (LAN), a wide area network (WAN), a metropolitan area network (MAN), or through one or more portions of the Internet or a combination of two or more of these. One or more portions of one or more of these networks may be wired or wireless. One or more portions of one or more of these networks may use standard or proprietary protocols. Interface 217 may be able to communicate with a wireless PAN (WPAN) (such as, for example, a BLUETOOTH WPAN), a Wi-Fi network, a WI-MAX network, an LTE network, an LTE-A network, a cellular telephone network (such as, for example, a Global System for Mobile Communications (GSM) network), or any other suitable wireless network or a combination of two or more of these.

In some embodiments, interface 217 may include one or more interfaces for one or more I/O devices. One or more of these I/O devices may enable communication between an operator or user and first-hop node 220. As an example and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these. An I/O device may include one or more sensors. Particular embodiments may include any suitable type and/or number of I/O devices and any suitable type and/or number of interfaces 217 for them. Where appropriate, interface 217 may include one or more drivers enabling processor 211 to drive one or more of these I/O devices. First-hop node 220 may include any suitable number of any suitable type of interface 217 for any one or more of networks and/or I/O devices, where appropriate.

Bus 212 may include any combination of hardware, software embedded in a computer readable medium, and/or encoded logic incorporated in hardware or otherwise stored (e.g., firmware) to couple components of first-hop node 220 to each other. As an example and not by way of limitation, bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or any other suitable bus or a combination of two or more of these. Bus 212 may include any number, type, and/or configuration of buses 212, where appropriate. In particular embodiments, one or more buses 212 (which may each include an address bus and a data bus) may couple processor 211 to storage 213. Bus 212 may include one or more memory buses.

Herein, reference to a computer-readable storage medium encompasses one or more tangible and non-transitory computer-readable storage media possessing structures. As an example, and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, a flash memory card, a flash memory drive, or any other suitable tangible computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101.

Particular embodiments may include one or more non-transitory computer-readable storage media implementing any suitable storage. In particular embodiments, a computer-readable storage medium implements one or more portions of processor 211 (such as, for example, one or more internal registers or caches), one or more portions of storage 213, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody encoded software.

Herein, reference to encoded software may encompass one or more applications, bytecode, one or more computer programs, one or more executables, one or more instructions, logic, machine code, one or more scripts, or source code, and vice versa, where appropriate, that have been stored or encoded in a computer-readable storage medium. In particular embodiments, encoded software includes one or more application programming interfaces (APIs) stored or encoded in a computer-readable storage medium. Particular embodiments may use any suitable encoded software written or otherwise expressed in any suitable programming language or combination of programming languages stored or encoded in any suitable type or number of computer-readable storage media. In particular embodiments, encoded software may be expressed as source code or object code. In particular embodiments, encoded software is expressed in a higher-level programming language, such as, for example, C, Perl, or a suitable extension thereof. In particular embodiments, encoded software is expressed in a lower-level programming language, such as assembly language (or machine code). In particular embodiments, encoded software is expressed in JAVA. In particular embodiments, encoded software is expressed in Hyper Text Markup Language (HTML), Extensible Markup Language (XML), or other suitable markup language.

The following example may help to illustrate certain features and benefits of particular embodiments. For purposes of this example it may be assumed that source 210 has data that it wants to make available to a group for which there are currently no members. In this example, the components of first-hop node 220 may work together to reduce the amount of wasted data communicated through network 200. In certain embodiments, interface 217 may receive one or more messages from source 210. One such message, such as an interest solicitation message, may indicate that source 210 has data that it wants to make available to any members of a group. The message may include a source identifier that identifies source 210 and a group identifier that identifies the group for which the data is to be made available.

The source identifier may correspond to an address, such as an IP address, associated with source 210. This may allow processor 211 to determine the location and/or identity of source 210. The group identifier may correspond to a name, number, address, or other identifier associated with a group. The group may include endpoints that are interested in receiving the data from source 210. In some embodiments, the group identifier may identify the data that is being provided by source 210.

After interface 217 has received the message, the message (or a portion thereof) may be stored in storage 213. In some embodiments, processor 211 may extract the group identifier and source identifier from the message. The extracted information may replace, or be stored with, the message. Processor 211 may use the extracted information to generate a message for interface 217 to send to RN 240. For example, processor 211 may generate a null register message that interface 217 may send to RN 240. A null register message may pass through any number of nodes 230 enroute to RN 240. For example, in the depicted embodiment, the null register message may pass through node 230a. In some embodiments, interface 217 may periodically and/or repeatedly send null messages (e.g., null register messages) for as long as source 210 has the data available.

The null register message may include the source identifier and the group identifier extracted by processor 211 from the message from source 210. The null register message may not include any of the data that source 210 is making available. This may allow the null register messages sent from first-hop node 220 to RN 240 to contain substantially less data, and be substantially smaller in size, than a typical register message which would include encapsulated data from the data source.

RN 240 may receive the null register message from first-hop node 220 and extract the group identifier and source identifier. From this extracted information, RN 240 may update its internal storage (e.g., a database, chart, look-up-table, or other organization of data) to reflect that source 210 has data available for any members of the group specified in the extracted group identifier. If endpoint 250, which may not know the identity or address of source 210, wants to receive the data provided by source 210, endpoint 250 may send a join message to RN 240. The join message may simply identify the group that endpoint 250 would like to join. RN 240 may use the data it extracted from the null message to determine that source 210 has the data for the group which endpoint 250 requested to join.

Interface 217 may then receive an indication that endpoint 250 has joined the group for which source 210 has available data. In some embodiments, the indication may merely provide notice that an endpoint (e.g., without specifically identifying endpoint 250) has joined the group and wants to receive the data. Based on the received join message from RN 240, processor 211 may update a table, or other organization of data, to reflect that there is at least one endpoint interested in receiving the data from source 210. In some embodiments, this information may be maintained in an out-list. In particular embodiments, the out-list may list the interfaces, including possibly interface 217, through which first-hop node 220 may send the data received from source 210. In some embodiments, the out-list may list the endpoints (e.g., endpoint 250) interested in receiving the data from source 210.

In certain embodiments, once first-hop node 220 has received its first join message for the group, processor 211 may add the interface from which the join message was received (e.g., interface 217) to the out-list (or it may form a new out-list that includes the appropriate interface). Interface 217 may then send a message to source 210 indicating that there is at least one endpoint in the group and that source 210 may begin to transmit the data. In certain embodiments, the data may be streamed to endpoint 250 without passing through RN 240. The interfaces listed in the out-list may be used to create a connection between source 210 and endpoint 250. This may allow the data to be sent from source 210 to endpoint 250 without having to go through RN 240. In some embodiments, once source 210 begins transmitting the data, interface 217 may continue sending the null register messages to RN 240. In some embodiments, once source 210 begins transmitting the data, interface 217 may stop sending the null register messages to RN 240. In particular embodiments, processor 211 may extract an address or other identification of endpoint 250.

In some instances, while source 210 still has data available, endpoint 250 may decide that it no longer wishes to receive the data from source 210. In such an instance, endpoint 250 may send an un-join message (e.g., a prune message) requesting to be removed from the group. The un-join message may, in essence, request to no longer receive the data from source 210. In particular embodiments, the un-join message may be sent to RN 240 and RN 240 may forward the un-join message to source 210. In other embodiments, the un-join message may be sent to source 210. Regardless of the route of the un-join message, when interface 217 receives the un-join message, the out-list stored in storage 213 may be updated by processor 211. For example, processor 211 may remove the interface, such as interface 217, and/or endpoint 250 from the out-list.

Each time processor 211 updates the out-list, it may determine whether there are any remaining entries in the out-list. As long as there are entries in the out-list, indicating that there are members in the group that still want to receive the data from source 210, source 210 may continue to send the data. If the out-list does not contain any entries, processor 211 may generate a stop message which interface 217 may send to source 210. When source 210 receives the stop message, it may stop the transmitting of the data. If the data is to remain available from source 210, even after source 210 has stopped transmitting the data, interface 217 may continue or resume sending messages, such as the null register messages, to RN 130 in case any other endpoints wish to join the group. In some embodiments, the null register messages may be sent to RN 130 regardless of whether or not there are any endpoints in the group.

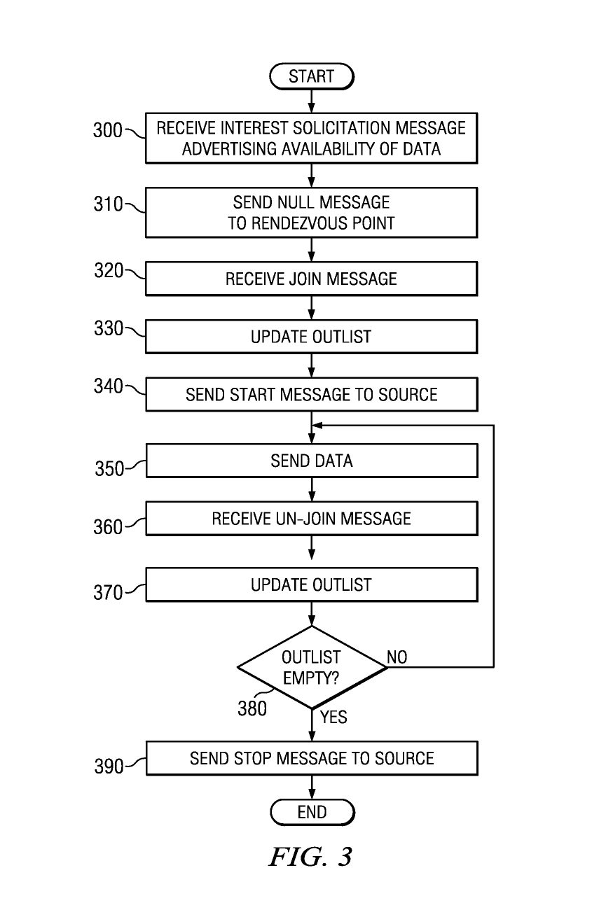

FIG. 3 illustrates a method for implementing multicast source registration, in accordance with particular embodiments. The method depicted in FIG. 3 includes steps described from the perspective of a first-hop node in a network. The method begins at step 300 where an interest solicitation message is received. The interest solicitation message may be an advertisement advertising the availability of data from a source. The interest solicitation message may be one of many interest solicitation messages received by the first-hop node. In some embodiments, the interest solicitation message may include a source identifier and a group identifier. The source identifier may identify the source of data. For example, the source identifier may include an IP address or other address or identification that is associated with the source of the data. The group identifier may identify at least one group with which the data provided by the source is associated. In some embodiments, the members of a group may comprise any endpoints that are interested in the data. If an endpoint is interested in receiving the data, the endpoint may join the group without having to know the identity of the source of the data.

At step 310 a null message is sent to a rendezvous node. The rendezvous node may be similar to rendezvous nodes 130 or 240 depicted in FIGS. 1 and 2 respectively. In particular embodiments, the null message may be a null register message used in Protocol Independent Multicast (PIM) sparse mode. PIM may be a protocol for efficiently routing packets to multicast groups that may span wide areas within a domain network. The null message sent may be referred to as such because it may not contain any encapsulation of the data that the source is making available to the group. This may reduce the amount of source resources and network resources wasted on sending the encapsulated data when there are no members in the group. The null register message may be used by the rendezvous node to update and/or maintain a table (or other organization of data) that includes the group identifier and the source identifier. The table may include identifiers for several different sources and several different groups.

At step 320 a join message is received. The join message may originate from an endpoint that wishes to receive the data from the source. The join message may initially be sent from the endpoint to the rendezvous node. When the endpoint sends the initial join message, the endpoint may know the group identifier but not the identity of the source of the desired data. The rendezvous node may identify the first-hop node based on group identifier in the initial join message and the table with the information from the null register message. The rendezvous node may then forward a join message to the first-hop node.

At step 330 an out-list is updated. The out-list may be a list, maintained by the first-hop node, that identifies the endpoints (e.g., via the interface from which the join message was received) interested in receiving data from the source. In some embodiments, the first-hop node may maintain an out-list for each group and/or each data source that has data available (and which is routed through the first-hop node). In some embodiments, each entry in the out-list may identify the interface that received the join message and/or the respective endpoint that has joined the group. In other embodiments, the first-hop node may be unaware of the identity of the endpoints, the out-list may simply list or identify that there are endpoints interested in receiving the data or the out-list may keep a count of the numbers of endpoints in the group.

At step 340 a start message is sent to the source. The start message may be sent to signal to the source that there are members in the group and that the source can begin transmitting the data. In certain embodiments, or scenarios, a start message may be sent the first time the join message is received (e.g., any time the source has data but there were no members in the group prior to the join message). Once the source begins transmitting data, it may be unnecessary to send additional start messages as other endpoints join the group because the source is already transmitting the data.

At step 350, the first-hop node begins sending data. The data sent may be data received from the source. Depending on the number of endpoints within the group, the data may be sent to a corresponding number of different destinations. In some embodiments, the data may be sent to the endpoints of the group without going through the rendezvous node. This may reduce the amount of traffic that is sent to the rendezvous node, and thus the amount of traffic in the network as a whole. In particular embodiments, the data may be sent based on the out-list. In some embodiments, the source may be providing a stream of data such that the data sent at step 350 is a stream of data.

At step 360 an un-join message is received. The un-join message may be sent by the endpoint when the endpoint no longer desires to receive data from the source. The un-join message may, in effect, remove the endpoint from the group. In some embodiments, the un-join message may be received in a similar fashion as the join message at step 320. For example, the un-join message may be generated by an endpoint within the group and sent to the rendezvous node or first-hop node. The rendezvous node may then forward the un-join message on to the first-hop node. In some embodiments, the un-join message may be sent from the endpoint to the first-hop node without going through the rendezvous node.

At step 370 the out-list is updated. Because the endpoint no longer wishes to be a member of the group, the entry (e.g., the interface) within the out-list associated with the endpoint is removed. At step 380, the first-hop node examines the out-list to determine whether there are any endpoints within the group. If there are still endpoints in the group, the first-hop node continues to send the data received from the source. If the group is empty, the method continues to step 390.

At step 390 the first-hop node sends a stop message to the source. The stop message may indicate to the source that there are no endpoints within the group interested in receiving the data. This may allow the source to stop transmitting the data. This may also avoid consuming network resources transmitting data which no one is interested in receiving. In some embodiments, even though the source is no longer transmitting the data, if the source is still available to transmit the data, the first-hop node may continue to send null messages to the rendezvous node. This may alert the rendezvous node to the fact that the source is still available to provide the data to the group. Then, if any endpoint wants to receive the data later, the rendezvous node is able to forward a join message from the endpoint to the first-hop node.

Although the depicted embodiment includes a particular number of steps arranged in a particular order, additional steps may be added, certain steps may be removed or skipped, or the steps may be performed in a different order. For example, several endpoints may all join a group within a relatively short period of time, and steps 320 through 330 may be repeated several times before data is sent at step 350. As another example, if no endpoints join the group identified in the solicitation message received at step 300, then steps 320 through 390 may not be performed. As yet another example, similar to the one previous, in some embodiments, the null message sent to the rendezvous node at step 310 may be repeated several times while waiting for an endpoint to join the group. This may keep the rendezvous node apprised of the fact that the source is still available to transmit the data once an endpoint joins the group.

Technical advantages of particular embodiments may include allowing a source to advertise the availability of data without consuming network resources transmitting the data when there is no one interested in receiving the data. Moreover, the source of the data may conserve its own resources in not sending the data when there are no receivers. Other technical advantages will be readily apparent to one of ordinary skill in the art from the figures, descriptions, and claims provided herein. Moreover, while specific advantages have been enumerated above, various embodiments may include all, some, or none of the enumerated advantages.

Although particular embodiments have been described in detail, it should be understood that various other changes, substitutions, combinations and alterations may be made hereto without departing from the spirit and scope of the disclosure. Particular embodiments may combine one or more features depending on operational needs and/or component limitations. This may allow for great adaptability to the needs of various organizations and users. Some embodiments may include additional features. It is intended that particular embodiments encompass all such changes, substitutions, variations, alterations and modifications as falling within the spirit and scope of the appended claims. For example, although an embodiment has been described with reference to a number of elements included within network 100, such as sources, first-hop nodes, rendezvous nodes, and endpoints, these elements may be combined, rearranged or positioned in order to accommodate particular routing and/or multicast registration needs. In addition, any of these elements may be provided as integrated internal or separate external components to each other where appropriate. Particular embodiments contemplate great flexibility in the arrangement of these elements as well as their internal components.

What is claimed:

1. A method comprising:
receiving an interest solicitation message advertising an availability of data from at least one source of a plurality of sources, the interest solicitation message comprising a source identifier indentifying the at least one source and a group identifier identifying at least one group;
sending a null message to a rendezvous node, the null message comprising the source identifier and the group identifier;
receiving, via the rendezvous node, a join message indicating that at least one endpoint has requested to join the at least one group identified by the group identifier;
sending a start message to the at least one source, the start message indicating that at least one endpoint has requested to join the group; and
receiving a first portion of the data after sending the start message.

2. The method of claim 1, further comprising updating an out-list associated with the at least one source.

3. The method of claim 1, wherein the data is multicast data.

4. The method of claim 1, further comprising sending the first portion of the data to the endpoint.

5. The method of claim 1, further comprising:
receiving an un-join message indicating that the at least one endpoint has requested to no longer be a member of the at least one group; and
upon determining that there are no members of the at least one group, sending a stop message to the at least one source, the stop message indicating that there are no endpoints receiving the data.

6. The method of claim 1, wherein the interest solicitation message is received without itself including any portion of the data.

7. The method of claim 1, wherein the interest solicitation message is received before any of the data is received.

8. A non-transitory computer readable medium comprising logic that when executed by a processor is configured to:
receive an interest solicitation message advertising an availability of data from at least one source of a plurality of sources, the interest solicitation message comprising a source identifier indentifying the at least one source and a group identifier identifying at least one group;
send a null message to a rendezvous node, the null message comprising the source identifier and the group identifier;
receive, via the rendezvous node, a join message indicating that at least one endpoint has requested to join the at least one group identified by the group identifier;
send a start message to the at least one source, the start message indicating that at least one endpoint has requested to join the group; and
receive a first portion of the data after sending the start message.

9. The medium of claim 8, wherein the logic is further configured to update an out-list associated with the at least one source.

10. The medium of claim 8, wherein the data is multicast data.

11. The medium of claim 8, wherein the logic is further configured to send the first portion of the data to the endpoint.

12. The medium of claim 8, wherein the logic is further configured to:
receive an un-join message indicating that the at least one endpoint has requested to no longer be a member of the at least one group; and
upon determining that there are no members of the at least one group, send a stop message to the at least one source, the stop message indicating that there are no endpoints receiving the data.

13. The medium of claim 8, wherein the interest solicitation message is received without itself including any portion of the data.

14. The medium of claim 8, wherein the interest solicitation message is received before any of the data is received.

15. An apparatus comprising:
an interface configured to receive an interest solicitation message advertising an availability of data from at least one source of a plurality of sources, the interest solicitation message comprising a source identifier indentifying the at least one source and a group identifier identifying at least one group; and
a processor coupled to the interface and configured to generate a null message based on the source identifier and the group identifier;
the interface further configured to:
send a null message to a rendezvous node;
receive, via the rendezvous node, a join message indicating that at least one endpoint has requested to join the at least one group identified by the group identifier;
send a start message to the at least one source, the start message indicating that at least one endpoint has requested to join the group; and
receive a first portion of the data after sending the start message.

16. The apparatus of claim 15, wherein the processor is further configured to update an out-list associated with the at least one source.

17. The apparatus of claim 15, wherein the data is multicast data.

18. The apparatus of claim 15, wherein the interface is further configured to send the first portion of the data to the endpoint.

19. The apparatus of claim 15:
wherein the interface is further configured to receive an un-join message indicating that the at least one endpoint has requested to no longer be a member of the at least one group;
wherein the processor is further configured to determine whether there are any members of the at least one group; and
wherein, upon determining that there are no members of the at least one group, the interface is further configured to send a stop message to the at least one source, the stop message indicating that there are no endpoints receiving the data.

20. The apparatus of claim 15, wherein the interest solicitation message is received without itself including any portion of the data.
